(19) United States
(12) Patent Application Publication
(10) Pub. No.: US 2005/0060394 A1
(43) Pub. Date: Mar. 17, 2005

(54) Programmable delay, transparent switching multi-port interface line card

(75) Inventors: Paul A. Frechette, Manchester, NH (US); Bernard A. Rozmovits, Londonderry, NH (US)

Correspondence Address: MAINE & ASMUS, 100 MAIN STREET, P O BOX 3445, NASHUA, NH, 03061-3445, US

(73) Assignee: Metrobility Optical Systems, Inc.

(21) Appl. No.: 10/658,854

(22) Filed: Sep. 11, 2003

(51) Int. Cl. G06F 15/173

(52) U.S. Cl. 709/223

(57) ABSTRACT

A network interface card and system incorporating the interface card with hardware link failure detect circuitry and operating system compliant driver and GUI management software and system operator selectable delay, to provide soft fail-over transfer from the primary to a secondary network link port without data loss. The systems comprising the multi-port interface card according to the present invention provide a single network and redundant paths with optional conversion to different data medium, e.g. between fiber optic and twisted pair, and also comprises multi-network configurations connecting common equipment having the multi-port interface card according to the present invention therein.

### FIELD OF THE INVENTION

The present invention relates to network systems and equipment network link adapter or interface cards, in particular to media adapter or Ethernet and other network media or interface cards having multiple ports and connected to redundant or multiple systems configured therefrom.

### BACKGROUND OF THE INVENTION

Typical system networks offering redundancies include a primary and a secondary network interface or interface card connected to the appropriate network destination. When a failure is detected in the primary network connection, the error in data flow is detected, but not quickly enough to avoid losing the data transmitted during that exchange. Furthermore, the secondary network interface has a different MAC address, contributing significantly to the delay in switch-over upon detected failure of the primary network interface path.

Heretofore, whenever there was a network failure, the end user always was aware of the failure, which resulted in a significant loss in data and time. Most networks attempt to provide resiliency in the core or backbone of the network, which becomes very complex when redundant paths are provided to multi-addressed fringe devices. The resulting increase in system complexity and convergence time often causes the end user to reboot their systems, or at least reconnect to the server when there is a network failure.

### SUMMARY OF THE INVENTION

The network interface cards and system according to the present invention includes a network interface main port typically connected to the user equipment or server clusters and dual (or redundant, multiple) network interface output ports through which data traffic is selectively sent, and hardware link failure detector circuitry integrated with an application or operating system-compliant driver and related GUI management software to provide operator alert and control, and controllable fail-over transfer to a secondary network link within in a predetermined software programmable time, transparent to the end user with no lost data. System implementations according to the present invention provides enhanced network data line protection and restoration in the event of data line failure. Moreover, the interface cards according to the present invention is similarly programmable to automatically restore network connections via the primary network link upon return of data activity to that link. Further embodiments of the present invention convert the input media, e.g. twisted wire pair, to a different output media, eg. Ethernet, single or multimode fiber optic.

In addition, representative redundant and multiple network system configurations are provided with the media converter/interface card and media converter according to the present invention to provide enhanced performance with reduced delays and data loss and improved operator control thereof.

### BRIEF DESCRIPTION OF THE DRAWING

These and further features of the present invention will be better understood by reading the following Detailed Description together with the Drawing, wherein

FIG. 1 is a block diagram of an exemplary ‘back-to-back’system embodiment having both primary and both secondary ports linked to each other according to the present invention;

FIG. 2 is a block diagram of an exemplary system embodiment having both primary and both secondary ports linked to each other via redundant primary and secondary switches;

FIG. 3 is an illustration of typical user GUI according to one embodiment of the present invention showing user control of switch-over parameters;

FIG. 4 is a block diagram of the one embodiment of the network interface card according to the embodiments present invention of FIGS. 1 and 2; and

FIG. 5 is a block diagram of one embodiment according to the present invention of the Multiplexer of FIG. 4.

### DETAILED DESCRIPTION OF THE INVENTION

A ‘back-to-back’ redundant network configuration 50 is provided in FIG. 1, wherein two switches 52, 54 are interconnected via interface card 60 according to one embodiment of the present invention, each having two output ports, the first ports being connected together and the second ports being connected together by twisted pair, fiber optic, or another data medium compatible with the interface card 60 output data and medium format. The interface cards optionally perform the function of translation from one medium, e.g. twisted pair (TP) from the switch 52, to another medium, e.g. fiber optic (FO). Typically, the interface cards 60 are grouped in chassis 62 and 64 along with other interface cards 60 to be connected to other equipment (not shown) and to a corresponding management card 69, which directs the operator selection of the interface card 60 operating parameters discussed below, to each of the selected interface cards 60 within the corresponding chassis 62, 64. Each of the management cards 69 is connected, such as by serial interface, to a programmable operator system, such as a typical PC 72 having the corresponding operator and driver systems to recognize and control the management cards 62, 64 and the subordinate interface cards 60. The exemplary system 50 of FIG. 1 provides protection from the failure of data paths 66A and 66B as described below.

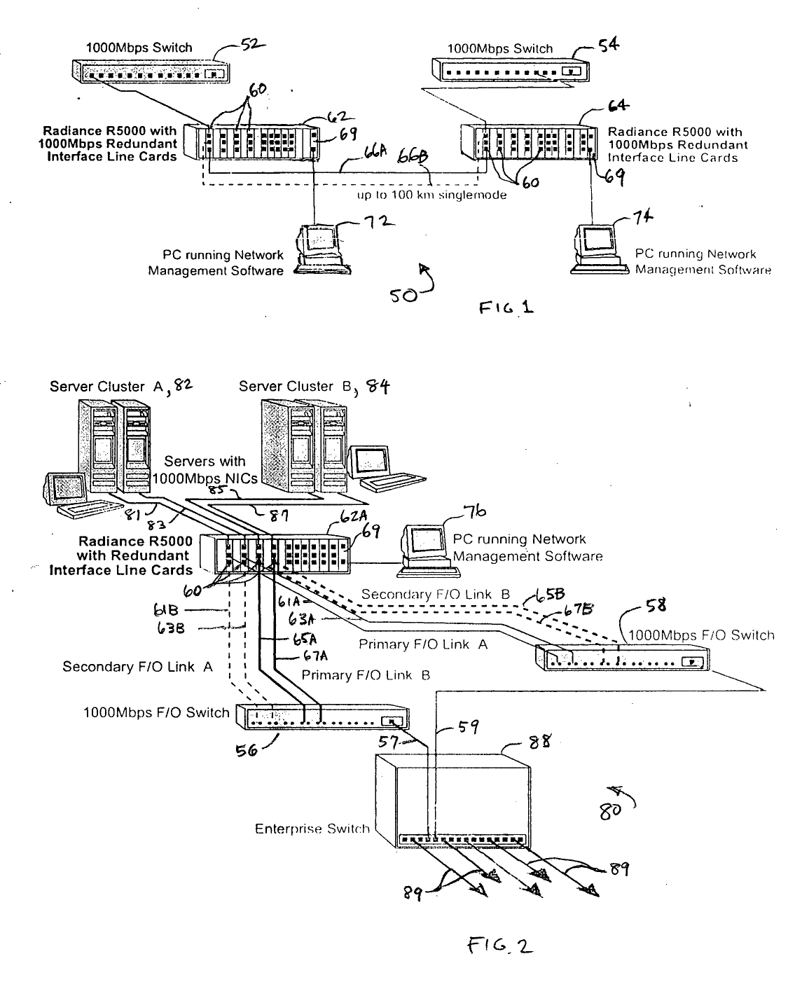

An alternate system embodiment 80 is shown in FIG. 2 wherein server clusters A and B, 82 and 84 respectively, are connected to the network interface cards 60 according to the present invention via data paths 81, 83 and 85, 87. The network interface cards 60 are housed in a common chassis 62A and having a common management card 69 controlled by a computer having the corresponding system and driver software components therein. Each network interface card 60 receives one of the incoming data traffic on a user selected media 81, 83, 85 and 87 and provides redundant primary and secondary output data paths 61A and 61B, 63A and 63B, 65A and 65B, and 67A and 67B on media which may differ from the incoming data path medium. In the exemplary embodiment 80 of FIG. 2, the network line card primary output signals 61A and 63A for the server cluster A, 82 are received by a switch 58 along with the network line card secondary output signal 65B and 67B for the server cluster B, 84, while the interface card primary output signals 65A and 67A for the server cluster B, 84 are received by a switch 56 with the interface card output signals secondary output signals 61B and 63B for the server cluster A, 82. The output signals data paths 57, 59 from the switches 56 and 58 are received by the switch 88 which provides network outputs signals along selected media 89. The network according to the embodiment 80 of FIG. 2 provides redundancy and switch (56, 58) or media failure protection as described below.

As previously mentioned, one or more network interface cards 60 are controlled by a management card 65 or management module under control of a programmable controller console 76, typically a programmed PC having the appropriate connection (e.g. serial) to the management card 65. The console 76 includes an operating system and an application, e.g the WebBeacon™, and NetBeacon™ of Metrobility, Inc., the programs and User Guides of which being incorporated by reference, which has the necessary hardware (e.g. 65, 60) drivers and user interface (discussed below) to provide operator selection of primary/secondary switching parameters.

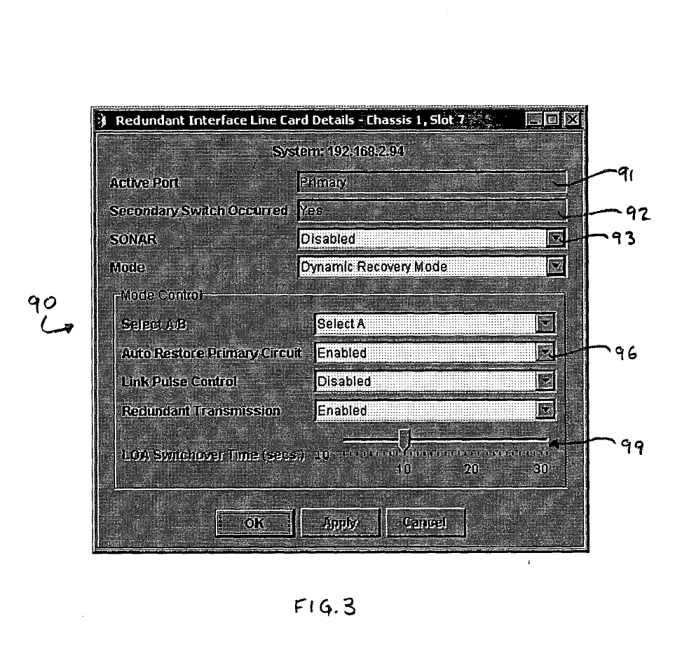

The monitoring of the configurations of FIGS. 1 and 2 is typically provided by a user Graphic User Interface (GUI) 90 as illustrated in FIG. 3. such as provided by a console machine (76) having the necessary operating system and management card 65 driver. The active port is indicated 91 as is the occurrence of a switch-over, 92 to the secondary port. In this particular GUI ‘screen shot’, we see that the SONAR (Switch On No Activity Received) is disabled. When enabled, the interface card 60 switch (or 'Fail-Over) from primary to secondary port occurs when the active port stops receiving activity as determined by the PHY hardware on the interface card 60, discussed below. A Dynamic Recovery Mode is selected at 94. Automatic restoration to the primary port circuit (from the secondary port) is selected as indicated at 96, and the time (1-32 seconds) after switch-over to occur after the conditions, e.g. SONAR active indicate that the primary port is inactive or otherwise a switch-over is required is shown at 99. A further feature is to verify the data traffic on the secondary port circuit before the interface line card switches to the secondary port. Such GUI controls provide operator control of the interface card 60 as provided by software controls (e.g. NetBeacon) of the interface card 60 internal registers by available programming techniques.

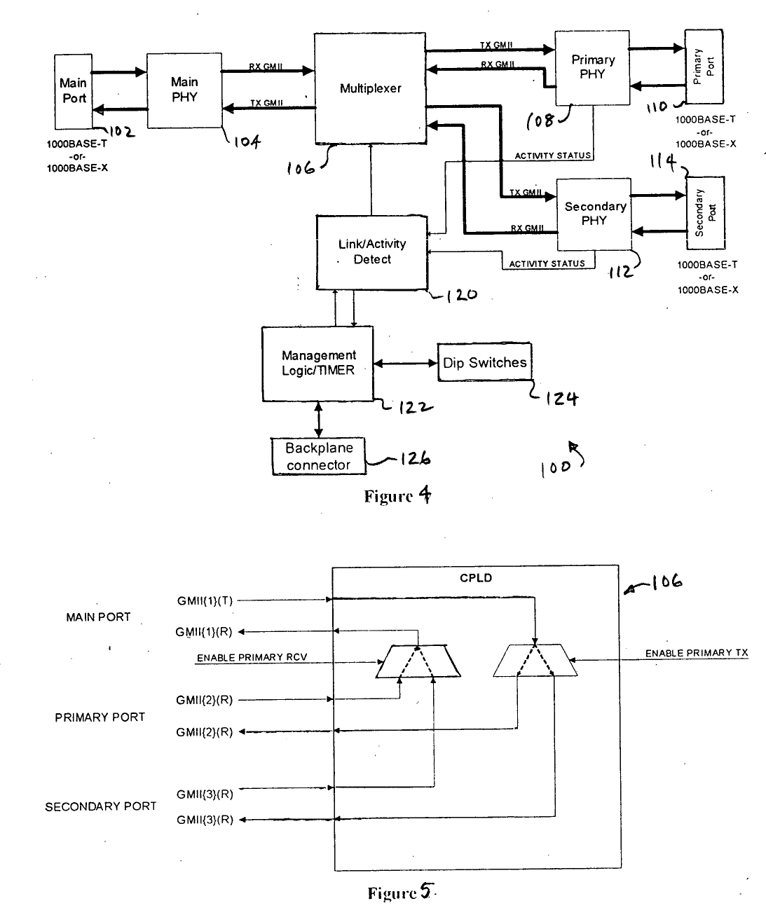

A block diagram 100 of one embodiment of the present invention is shown in FIG. 4, wherein the main port 102 interface connects to the equipment 62 and to the Main PHY 104, which is in turn connected to the Multiplexer 106 main port connections. The Multiplexer 106 primary port connections are received by the Primary PHY 108, which is in turn connected to the Primary Port interface 110. Similarly, the Multiplexer has secondary port connections received by a Secondary PHY 112, which is in turn connected to the Secondary Port interface 114. The interfaces 102, 112 and 114 provide an interface from the respective PHY protocol to 1000Base-T, 1000Base-X, Gigabit Ethernet. When enabled, the selected primary or secondary port will translate the data to GMII format, for example, and communicate via the Multiplexer 106 with the Main port after being translated back from GMII format. Also, the converse communication flow is provided as well. Other internal and external data formats are within the scope of the present invention, and media conversion is provided by providing the corresponding media main, primary and secondary ports (102, 110 and 114) and PHY layers (104, 108 and 112).

Each of the Primary and Secondary PHY 108, 112 also provides a logic signal indicating the presence of data activity from the corresponding port interface 110, 114, which signals are received by a Link Activity Detector logic 120, typically implemented on Complex Programmable Logic Devices (CPLD), to provide a control signal to the Multiplexer 106 (enable primary RCV and enable primary TX, FIG. 5, below) according to the detected primary or secondary port activity (or inactivity) and according to control signals provided by the Management Logic and Timer 122. The Management Logic and Timer 122 receives control signals from the host computer (console), e.g. 72, via the backplane connector 126 according to the operator selections made via the GUI 70 of FIG. 3. The Management Logic and Timer 122 includes a timer set according to the GUI directives for 1-32 (typically) seconds to elapse after an inactive status is received from the selected primary or secondary PHY 108, 112, after which an ‘end-of-time’ signal is generated which together with a detection of activity on the other port circuit PHY, causes or enables the Multiplexer 106 to switch from one (of primary or secondary) to the other port. Additional interface card 60 functions are selectively controllable via switches 124 located on each interface card 60. If the ‘Auto Restore’ feature is enabled 76, FIG. 3, the data will again be redirected via the Management Logic 122, Link Activity Detector 120 and Multiplexer 106 to initially selected link upon return of data activity as indicated by the corresponding activity status signal. Other greater or lesser time intervals may be accommodated by the Management Logic and Timer 122 according to the present invention.

The internal structure of the Multiplexer CPLD 106 is shown in FIG. 5, wherein the primary-to-main port transmit (TX) and receive (RCV) paths are provided and active according to signals on the corresponding enable primary TX and RCV inputs; otherwise, the RX and RCV data paths are provided between the secondary and main port connections.

Modifications and substitutions according to the present invention are within the scope of the present application, which is not to be limited except by the claims which follow. Moreover, while the multi-port interface card/media converter according to the present invention is illustrated by exemplary embodiments having two data links, the scope of the present invention also includes embodiments having additional secondary ports selectably enabled and accessed as describe above regarding two output ports. Such additional secondary ports are configured from additional physical port circuits, multiplexers having correspondingly wider input/output capacities, larger control/status registers and correspondingly expanded software driver control and support.

1. A network interface, comprising:
a plurality of physical ports, including one primary and at least one secondary port and each providing corresponding activity status signals and a main port having said physical address;
a data multiplexer connected to said plurality of physical ports for selectively providing a data flow between said main port and a selected one of said primary and secondary ports according to a control signal; and
a controller connected to said data multiplexer for selecting which port provides data flow to and from said main port, further including
a management control adapted to receive control signals from a host machine and including a timer for providing an output signal at an interval programmable according to said host machine control signals,
a link activity detector connected to receive said primary and secondary port activity status signals and provide a corresponding signals to said management control, wherein
said management control timer is further responsive to the selective one of said primary and secondary port activity status signals to begin a programmed interval, and said management control further includes logic means to provide said multiplexer control signal upon receipt of said timer output signal and the presence of data activity of a non-selected port, whereupon said multiplexer provides connection between said main port and said non-selected port.

2. The Network Interface of claim 1, further including an operator host machine for communicating with said management logic.

3. The Network Interface of claim 2, wherein said host machine further includes an applet providing selected operator control of said management logic.

4. The Network Interface of claim 3, wherein said host machine applet includes a GUI providing said selected operator control.

5. The Network Interface of claim 1, wherein said timer interval is programmable between 1 to 32 seconds, inclusive.

6. A software multi-port control system for a local machine having an operating system, comprising:
a configuration manager applet operable to configure a multi-port network interface controllable by a specific local machine; and
a multi-port network interface driver program operable by said operating system responsive to a network interface card having selectable multiple physical ports to selectively provide data to and receive data from a selected port of said network interface card according to a control signal; and
a programmable timer responsive to data flow through said selected port, for providing said control signal according to a time interval programmable by said applet.
